(19) United States
(12) Patent Application Publication
(10) Pub. No.: US 2011/0131255 A1
(43) Pub. Date: Jun. 2, 2011

(54) WIRELESS BASE STATION DEVICE AND OPERATION INFORMATION COLLECTION METHOD FOR THE SAME

(75) Inventor: Saiki KAWAMURA, Kawasaki (JP)

(73) Assignee: FUJITSU LIMITED, Kawasaki-shi (JP)

(21) Appl. No.: 12/954,764

(22) Filed: Nov. 26, 2010

(30) Foreign Application Priority Data
Nov. 30, 2009 (JP) 2009-271171

(51) Int. Cl. G06F 17/30; H04B 7/00

(52) U.S. Cl. 707/812; 455/68; 707/E17.005

(57) ABSTRACT

A wireless base station device connected to a network and communicating with an external device includes: a control management unit to store operation information in a database and manage the operation information, and the control management unit includes an operation information read portion to read operation information from the database, supplied from the external device; a determination portion to determine whether or not the operation information is beyond a period of validity, read from the database along with the operation information that corresponds to the request; a operation information update portion to read the operation information that corresponds to the request from corresponding units when the operation information that corresponds to the request is beyond the period of validity, and updating the database; and a response transmission portion to transmit the operation information to the external device.

### CROSS-REFERENCE TO RELATED APPLICATION

This application is based upon and claims the benefit of priority of the prior Japanese Patent Application No. 2009-271171, filed on Nov. 30, 2009, the entire contents of which are incorporated herein by reference.

### FIELD

A certain aspect of the embodiments discussed herein relates to a wireless base station device and an operation information collection method for the wireless base station device.

### BACKGROUND

Wireless base station devices (eNB) in mobile communication systems such as long term evolution (LTE) systems or the like often have a configuration in which a wireless device controller (base band unit: BBU) for establishing a connection with an upper switching device and performing a baseband processing operation and a wireless device (remote radio head: RRH) for establishing a wireless connection with a mobile terminal are separately provided.

FIG. 1 is a block configuration diagram illustrating an example of a wireless base station device. The wireless base station device includes a wireless device controller 1 and a wireless device 2. The wireless device controller 1 includes a highway unit 3, a control management unit 4, and a baseband processing unit 5. The highway unit 3 is connected through a network to a serving-gateway (S-GW) or a mobility management entity (MME), which is an upper switching device, and is also connected to a maintenance device. In addition, the highway unit 3 is connected to the control management unit 4 and the baseband processing unit (BB unit) 5 in the wireless device controller 1. The highway unit 3 transmits and receives information to and from the S-GW, the MME, and the maintenance device.

The control management unit 4 is connected to individual units in the wireless device controller 1 and the wireless device 2, and performs call control and control of individual units in the wireless base station device. In addition, the control management unit 4 manages operation information about the individual units in the wireless base station device. The baseband processing unit 5 is connected to the wireless device 2, and is also connected to the S-GW through the highway unit 3. In addition, the baseband processing unit 5 performs a baseband processing operation for an uplink and a downlink.

The wireless device 2 includes an antenna controller 6. The antenna controller 6 transmits and receives a wireless signal using an antenna 7. In addition, each of the highway unit 3, the control management unit 4, the baseband processing unit 5, and the antenna controller 6 includes one processor or a plurality of processors, and each processor distributes processing executed in the wireless base station device.

FIG. 2 illustrates a sequence of an example of a traffic data collection report of the related art. In FIG. 2, at a regular interval T1, the control management unit 4 sends a collection request for pieces of operation information such as IP addresses, traffic data, and the like to each of the baseband processing unit 5, the antenna controller 6, and the highway unit 3. Each of the baseband processing unit 5, the antenna controller 6, and the highway unit 3 includes operation information thereof in a response to the collection request and transmits the operation information to the control management unit 4, between processing operations executed in each of the baseband processing unit 5, the antenna controller 6, and the highway unit 3.

The control management unit 4 receives the response to the collection request from each of the baseband processing unit 5, the antenna controller 6, and the highway unit 3, and stores the operation information, included in the response, in a database in the control management unit 4. In the collection of the operation information, described above, all target items including information that has not updated are collected at the regular interval T1. Operation information, collected several times, is stored in the database, and the excess of the operation information over a certain amount is deleted in the chronological order, oldest first.

When receiving a read request, which designates an IP address or traffic data, from an external maintenance device through a network, the control management unit 4 transmits, as an IP address report or a traffic data report, an IP address or traffic data, stored in the database in the control management unit 4, to the maintenance device that is a request source.

In addition, a network management system has been proposed in which whether a node that corresponds to an IP address has a management condition for an unique IP address or a plurality of IP addresses is determined, and a management scheme is switched to a management scheme that matches the management condition of each node (for example, refer to Japanese Unexamined Patent Application Publication No. 2000-151599).

### SUMMARY

According to an aspect of an embodiment, a wireless base station device to connect to a network and communicate with an external device includes: a control management unit to store operation information in a database and manage the operation information, which relates to control of the communication and a processing operation performed in the wireless base station device, wherein the database stores therein an acquisition time and date and a period of validity along with the operation information, and the control management unit includes a operation information read portion to read operation information, which corresponds to a request, from the database in accordance with the request for reading the operation information, supplied from the external device; a determination portion to determine whether or not the operation information that corresponds to the request is beyond a period of validity on the basis of an acquisition time and date and a period of validity, read from the database along with the operation information that corresponds to the request; an operation information update portion to read the operation information that corresponds to the request from corresponding units when the operation information that corresponds to the request is beyond the period of validity, and updating the database; and a response transmission portion to transmit, as a response, the operation information read from the database or operation information that corresponds to a request for updating the database to the external device.

The object and advantages of the invention will be realized and attained by at least the elements, features, and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block configuration diagram of an example of a wireless base station device of the related art;

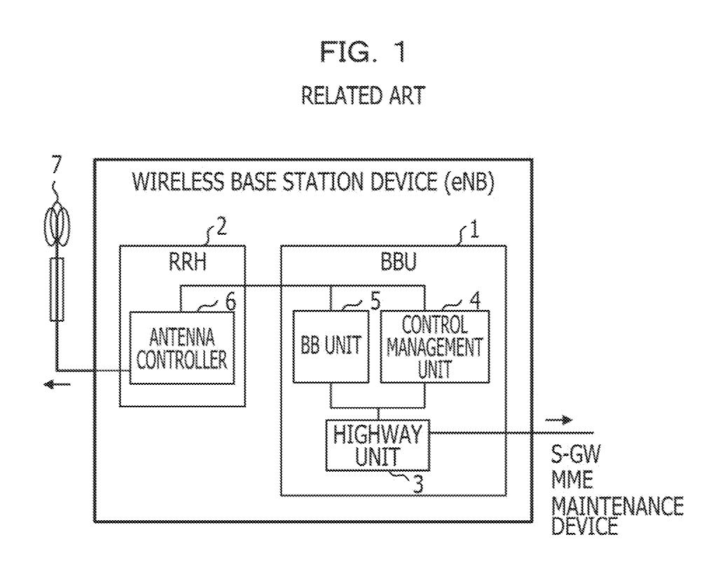

FIG. 2 is a diagram illustrating a sequence of an example of a traffic data collection report of the related art;

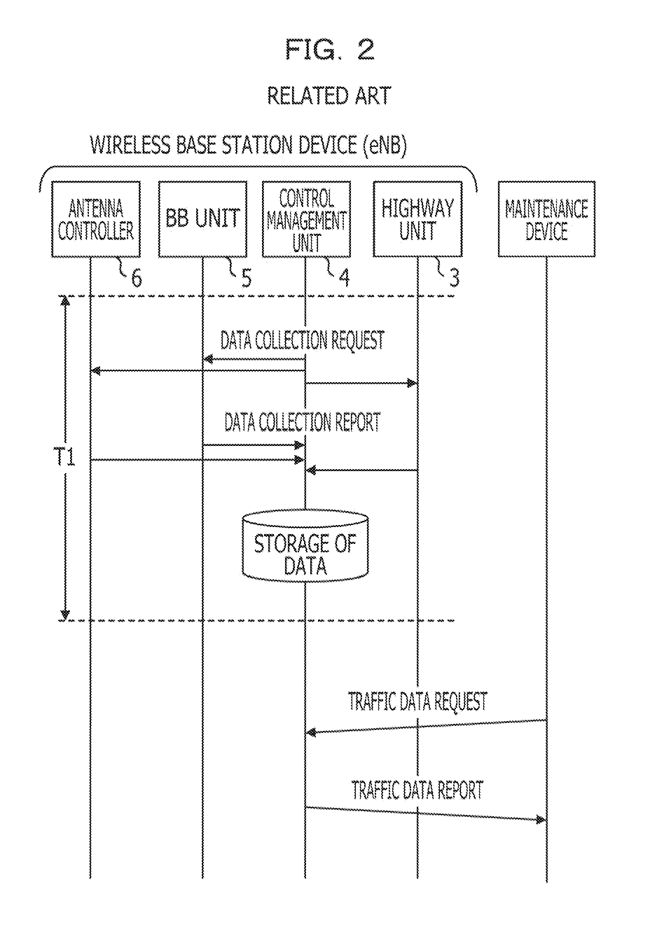

FIG. 3 is a configuration diagram of an embodiment of the wireless base station device;

FIG. 4 is a configuration diagram of an embodiment of a control management unit;

FIG. 5 is a configuration diagram of an embodiment of a highway unit;

FIG. 6 is a data configuration diagram of an embodiment of an MIB-DB;

FIG. 7 is a data configuration diagram of an embodiment of a data attribute table;

FIG. 8 is a sequence of an embodiment of an IP address collection operation;

FIG. 9 is a sequence of an embodiment of a regular collection operation;

FIG. 10 is a sequence of an embodiment of a new data collection operation;

FIG. 11 is a sequence of another embodiment of the new data collection operation;

FIG. 12 is a sequence of another embodiment of the new data collection operation;

FIG. 13 is a sequence of an embodiment of a composite data collection operation; and

FIG. 14 is a data configuration diagram of another embodiment of the MIB-DB.

### DESCRIPTION OF EMBODIMENTS

Since all target items are collected in the collection of operation information, a regular interval T1 is set to an interval such as, for example, of about 10 minutes. When a collection interval is this length, operation information stored in the database in the control management unit 4 becomes old, and hence turns out to be different from actual operation information in each of the baseband processing unit 5, the antenna controller 6, and the highway unit 3. In addition, if the collection interval is set to a shorter interval, a problem that the load of a collection processing operation for routine collection becomes great occurs.

An object of a wireless base station device disclosed in the application is that the load of a collection processing operation may be reduced and latest operation information may be collected.

According to the embodiment, the load of a collection processing operation may be reduced and latest operation information may be collected.

The embodiment will be described on the basis of figures, hereinafter.

### Configuration of Wireless Base Station Device

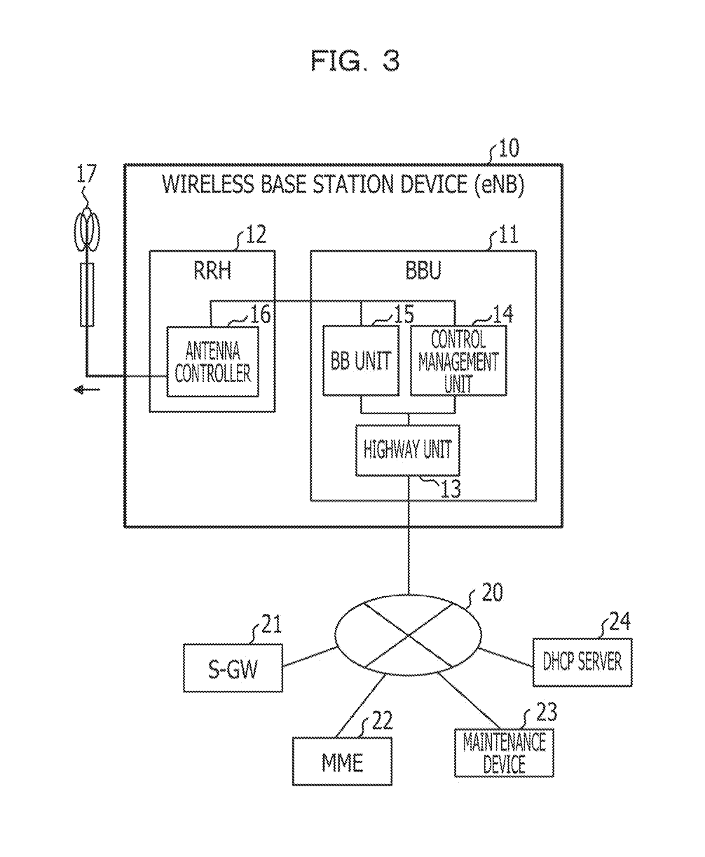

FIG. 3 illustrates a configuration diagram of an embodiment of the wireless base station device. In FIG. 3, a wireless base station device 10 includes a wireless device controller 11 and a wireless device 12. The wireless device controller 11 includes a highway unit 13, a control management unit 14, and a baseband processing unit 15. The highway unit 13 is connected through a network 20 to an S-GW 21 or an MME 22 that is an upper switching device, and is also connected to a maintenance device 23 and a dynamic host configuration protocol (DHCP) server 24. In addition, the highway unit 13 is connected to a control management unit 14 and a baseband processing unit (BB unit) 15 in the wireless device controller 11. The highway unit 13 transmits and receives information to and from the S-GW 21, the MME 22, the maintenance device 23, and the DHCP server 24.

The control management unit 14 is connected to individual units in the wireless base station device 10 and the wireless device 12, and performs call control and control of individual units in the wireless base station device 10. In addition, the control management unit 14 manages operation information about the individual units in the wireless base station device 10. The baseband processing unit 15 is connected to the wireless device 12, and is also connected to the S-GW 21 through the highway unit 13. In addition, the baseband processing unit 15 performs a baseband processing operation for an uplink and a downlink.

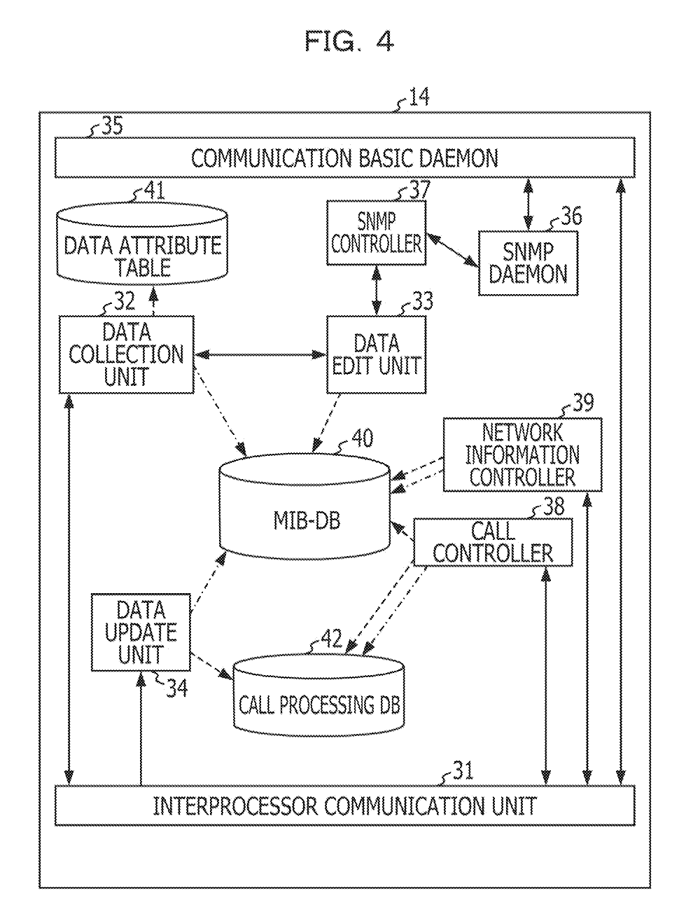

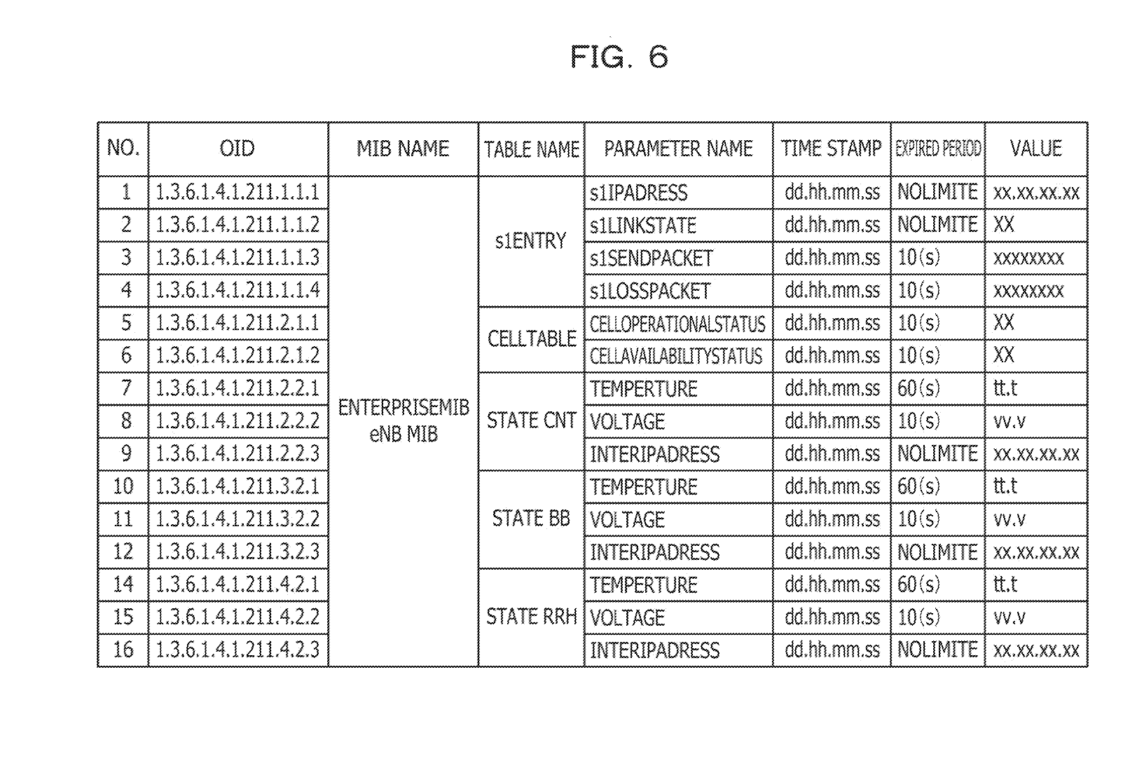

The control management unit 14 implements therein a management information base (MIB), and causes an MIB-database (MIB-DB) 40 to manage operation information about the wireless base station device 10. In addition, the MIB-DB 40 accesses using simple network management protocol (SNMP). In addition, the MIB-DB 40 will be described along with FIGS. 4 and 6.

The wireless device 12 includes an antenna controller 16. The antenna controller 16 transmits and receives a wireless signal using an antenna 17. In addition, each of the highway unit 13, the control management unit 14, the baseband processing unit 15, and the antenna controller 16 includes one processor or a plurality of processors, and processing executed in the wireless base station device 10 is distributed in each processor.

### Configuration of Control Management Unit

FIG. 4 illustrates a configuration diagram of an embodiment of the control management unit 14. In FIG. 4, dashed arrows indicate data references, dashed-dotted arrows indicate data updates, and solid arrows indicate processing requests and information reports.

In FIG. 4, an interprocessor communication unit 31 performs communication control between processors in individual units in the wireless base station device 10. On the basis of an instruction from a data edit unit 33, a data collection unit 32 instructs data collection units in individual units (the highway unit 13, the baseband processing unit 15, and the antenna controller 16) to collect latest data (operation information) with respect to data in the MIB-DB 40, which is beyond a period of validity. At this time, a data attribute table 41 is referred. The data collection unit 32 updates the MIB-DB 40 using the latest data that is collected, and notifies the data edit unit 33 of update completion.

The data edit unit 33 edits data in the MIB-DB 40 in response to a request from an SNMP controller 37. The data edit unit 33 confirms whether or not the time stamp of each of pieces of data is within a period of validity, and instructs the data collection unit 32 to collect data that is beyond the period of validity. After receiving a collection completion notification from the data collection unit 32, the data edit unit 33 continues editing data, and transmits the edited data to the SNMP controller 37.

A data update unit 34 regularly or irregularly receives data update requests from processors in the individual units (the highway unit 13, the baseband processing unit 15, and the antenna controller 16) in the wireless base station device 10, and updates the MIB-DB 40 in accordance with the received data update requests. Using an extension-line LAN, a communication basic daemon 35 transmits and receives a signal to and from the individual units (the highway unit 13, the baseband processing unit 15, and the antenna controller 16) in the wireless base station device 10.

An SNMP daemon 36 transmits and receives an SNMP message, and controls an SNMP protocol. An SNMP controller 37 receives a request based on SNMP from the SNMP daemon 36, and performs SNMP control for the wireless base station device 10.

Using a call processing database (DB) 42, a call controller 38 performs call control. Therefore, the call controller 38 configures a setting for connecting a call to the highway unit 13 and the baseband processing unit 15, and sets up in the highway unit 13 a conversion table between an extension-line IP address and an external-line IP address with respect to each GPRS tunneling protocol (GTP). A network information controller 39 manages IP addresses or the like for the self-wireless base station device, a peripheral wireless base station device, a facing maintenance device, an upper switching device, and the like. In addition, the wireless base station device 10 holds a plurality of IP addresses for many purposes so as to perform IP communication with peripheral devices such as a base station device, a facing maintenance device, an upper switching device, and the like. In addition, the call controller 38 instructs the highway unit 13 to acquire an IP address from the DHCP server 24.

### Configuration of Highway Unit

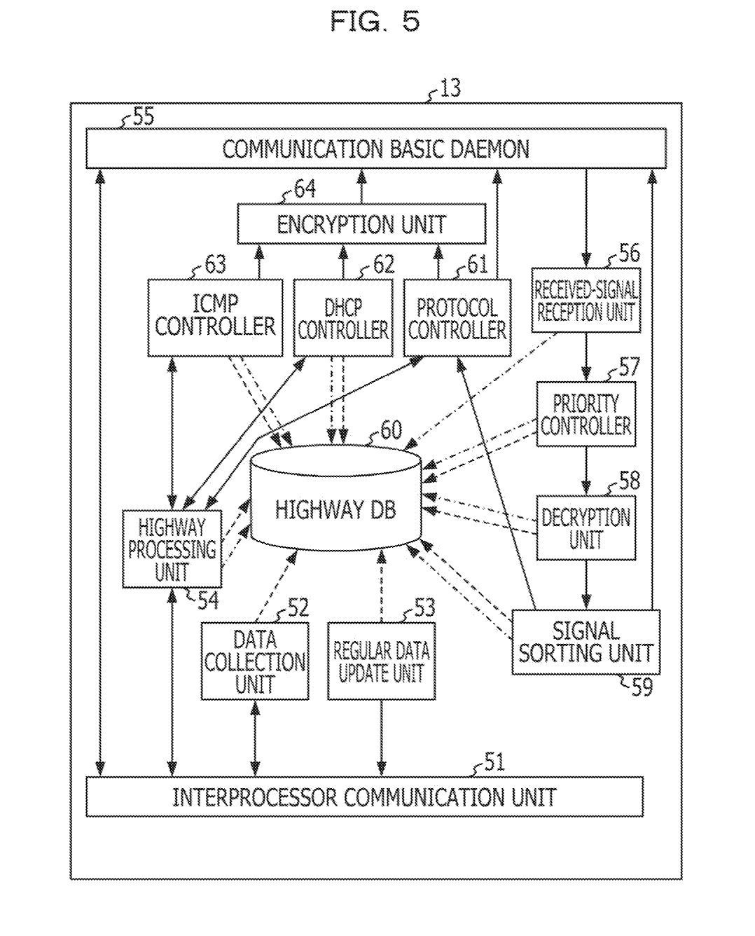

FIG. 5 illustrates a configuration diagram of an embodiment of the highway unit 13. In FIG. 5, dashed arrows indicate data references, dashed-dotted arrows indicate data updates, and solid arrows indicate processing requests and information reports.

In FIG. 5, an interprocessor communication unit 51 performs communication control between processors in individual units in the wireless base station device 10. A data collection unit 52 collects a request from the control management unit 14, or regularly collects data to be held in a highway DB 60 in the highway unit 13, and generates response data. A regular data update unit 53 reads, at a preliminarily scheduled interval, various kinds of data held in the highway DB 60, and transmits the read data to the control management unit 14.

In accordance with an instruction from the control management unit 14, a highway processing unit 54 sets up a conversion table between an extension-line IP address and an external-line IP address with respect to each GTP. In addition, the highway processing unit 54 configures settings for individual units in the highway unit 13, and configures a setting (data writing) for and reads data from the highway DB 60.

Using the network 20, which is an external LAN, and the extension-line LAN, a communication basic daemon 55 transmits and receives an IP packet. In addition, the communication basic daemon 55 counts the reception number of reception IP packets on a downlink, and stores the reception number in the highway DB 60. The received-signal reception unit 56 receives signals (IP packets) other than those in interprocessor communication.

A priority controller 57 performs buffering of and priority control for the reception IP packets in accordance with a communication service class or the like. In addition, the priority controller 57 counts the discard number of reception IP packets discarded on the basis of the result of the priority control, and stores the discard number in the highway DB 60. A decryption unit 58 decrypts a packet subjected to encryption (IP Security: IPSec).

A signal sorting unit 59 decrypts a L2 (layer 2)/L3 (layer 3) signal, and sorts the signal. Accordingly, an SNMP message is transmitted, for the control management unit 14, to the communication basic daemon 55, and a stream control transmission protocol (SCTP), a GTP, and the like are transmitted to a protocol controller 61. The protocol controller 61 provides protocols such as an SCTP, a GTP, an internet control message protocol (ICMP), and the like, for a wireless base station device, and counts the transmission number of transmission IP packets on an uplink, thereby storing the transmission number in the highway DB 60.

A DHCP controller 62 acquires a plurality of IP addresses from the external DHCP server 24 in accordance with a request from the highway processing unit 54. When an update deadline comes, the DHCP controller 62 accesses the DHCP server 24 to automatically update a plurality of IP addresses, and notifies the highway processing unit 54 of the update.

An ICMP controller 63 transmits an ICMP message in accordance with a request from the highway processing unit 54, and transmits and receives an ICMP message. An encryption unit 64 subjects a signal to be submitted to the external LAN to encryption (IPSec).

### Configuration of MIB-DB

In FIG. 6, a data configuration diagram of an embodiment of the MIB-DB 40 is illustrated. In the MIB-DB 40, a number is assigned to each of object IDs (OIDs). An MIB name, a table name, a parameter name, a time stamp for an acquisition time and date, a period of validity (Expired period), and a value (Value) are set in each OID. Here, for example, with respect to the table name, “s1Entry” indicates a link (uplink) to an upper switching device, “cellTable” indicates a cell table, “StateCNT” indicates the state of the control management unit 14, “StateBB” indicates the state of the baseband processing unit 15, and “StateRRH” indicates the state of the wireless device 12.

For example, with respect to the parameter name, “s1IPadoress” indicates the IP address of the self-device (the highway unit 13) that communicates with the upper switching device, “s1LinkState” indicates the state of the link to the upper switching device, “s1SendPacket” indicates the number of IP packets transmitted to the upper switching device, and “s1LossPacket” indicates the number of IP packets discarded without being transmitted to the upper switching device.

In addition, the time stamp indicates a time and date when the value (namely, data) of the OID is acquired. With respect to the period of validity, “NoLimite” indicates that the recency of a value (namely, data) is assured and the checking of the time deadline thereof is not necessary. With respect to the period of validity, “10 (s)” indicates 10 seconds.

The data collection unit 32 in the control management unit 14 described above compares a time when a read request is received from the maintenance device 23 with the time stamp and the period of validity of the MIB-DB 40, which correspond to an OID for which a read is requested. In addition, when the read request is received is within a time obtained by adding the time of the period of validity to the time of the time stamp, the data collection unit 32 sets the value (Value) of the OID in a response message for the read request, and transmits the response message to the maintenance device 23.

On the other hand, when the read request is received is beyond the time obtained by adding the time of the period of validity to the time of the time stamp, the data collection unit 32 executes, by referring the data attribute table 41, an internal read request, in which an internal request ID and an internal parameter ID are specified, for save locations (the highway unit 13, the baseband processing unit 15, the antenna controller 16, and the like) in which the data is saved. In addition, the data collection unit 32 reads latest data from the save locations in which the data is saved, sets the latest data in the response message for the read request, and transmits the response message to the maintenance device 23. In addition, the data collection unit 32 updates the data and the time stamp of the MIB-DB 40.

### Configuration of Data Attribute Table

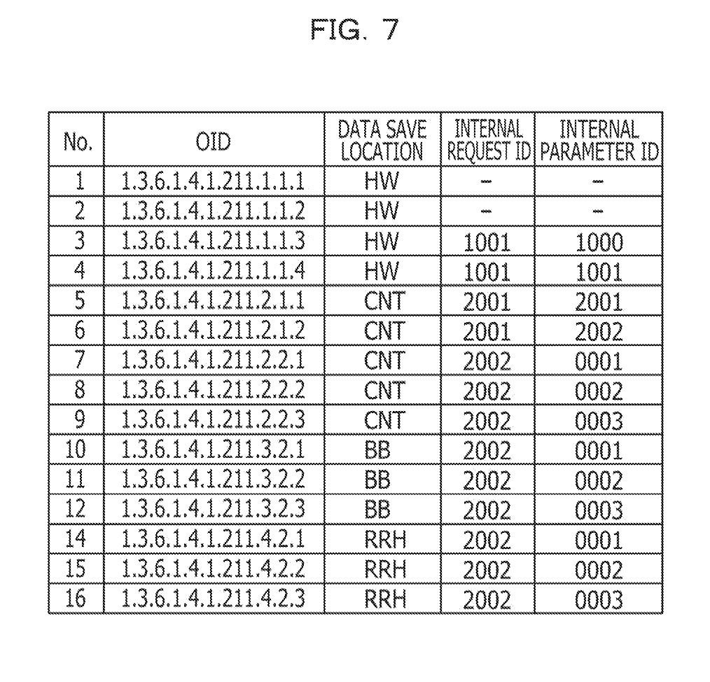

In FIG. 7, a data configuration diagram of an embodiment of the data attribute table 41 is illustrated. In the data attribute table 41, a number is assigned to each of object IDs (OIDs). A data save location, an internal request ID, and an internal parameter ID are individually set in each OID. Here, with respect to the data save location, “HW” indicates the highway unit 13, “CNT” indicates the control management unit 14, “BB” indicates the baseband processing unit 15, and “RRH” indicates the wireless device 12.

With respect to OIDs that have the same data save location and the internal request ID in the data attribute table 41, the control management unit 14 specifies a plurality of internal parameter IDs in a single read request, and hence may acquire the values (namely, data) of the plurality of internal parameter IDs. Accordingly, the number of times read requests are submitted may be reduced, and hence the load of a collection processing operation may be reduced.

### Collection of IP Address

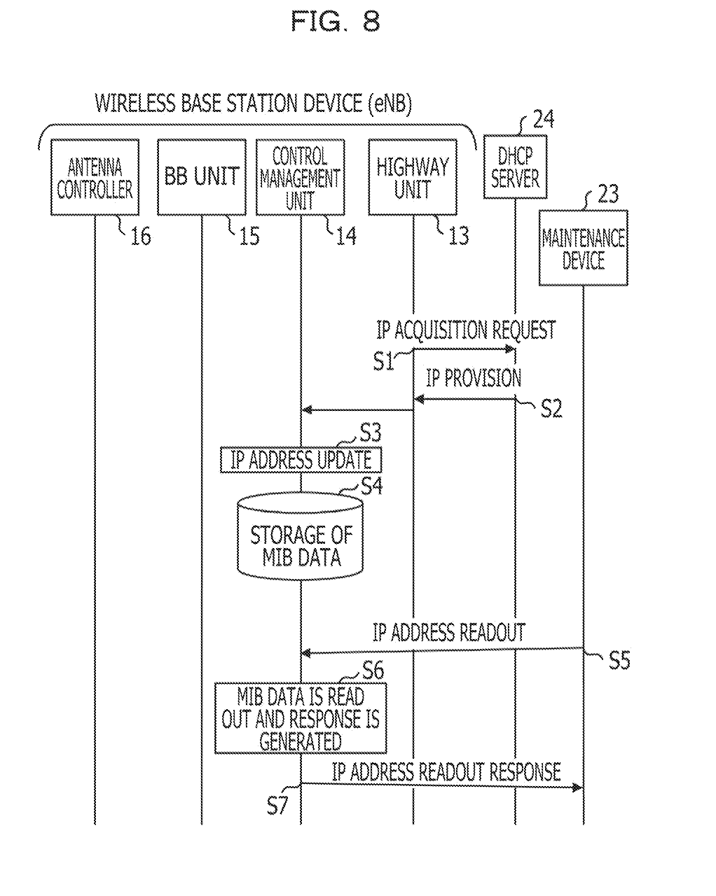

FIG. 8 illustrates a sequence of an embodiment of an IP address collection operation. In FIG. 8, for example, when the period of validity of an IP address of the control management unit 14 has expired, the DHCP controller 62 in the highway unit 13 transmits a request for automatic updating of the IP address to the DHCP server 24 (Operation S1).

The DHCP server 24 transmits an IP address to which a new period of validity is assigned to the highway unit 13 (IP provision), and the highway unit 13 transmits the received IP address of the control management unit 14 to the control management unit 14 (Operation S2).

The control management unit 14 sets the received IP address to a portion the period of validity of which has expired, and updates the IP address thereof (Operation S3). In addition, when the received IP address is, for example, the IP address of the baseband processing unit 15, Operation S3 is executed in the baseband processing unit 15.

In addition, the control management unit 14 writes the IP address into the MIB-DB 40 (namely, the “Value” of data in a specific OID in the MIB-DB 40), and updates the MIB-DB 40 (Operation S4). At this time, the period of validity of the IP address in the MIB-DB 40 is defined as “NoLimite”.

After this, for example, when the maintenance device 23 transmits an SNMP message that instructs to read the IP address of the control management unit 14 (which includes a specific OID indicating an IP address storage unit in the control management unit 14), the SNMP message is supplied to the control management unit 14 through the highway unit 13 in the wireless device controller 11 (Operation S5).

In response to the instruction of the received SNMP message, the control management unit 14 reads data, which corresponds to the IP address of the control management unit 14, from the MIB-DB 40. At this time, the period of validity of the IP address of the control management unit 14 corresponds to “NoLimite”. Therefore, the control management unit 14 generates an SNMP message used for an IP address read response that includes the IP address of the control management unit 14, which is read from the MIB-DB 40 (namely, the “Value” of data in a specific OID in the MIB-DB 40) (Operation S6), and transmits the SNMP message to the maintenance device 23 through the highway unit 13 (Operation S7).

In this way, a time stamp and a period of validity are set in data in the MIB-DB 40. In addition, for example, in a case in which a request for reading the IP address or the like of an arbitrarily portion is performed, when the IP address is within the period of validity, the MIB-DB 40 is not updated by reading the IP address of the arbitrarily portion but a response is performed by reading the IP address of the arbitrarily portion, which is stored in the MIB-DB 40. Therefore, the load of a collection processing operation can be reduced.

### Regular Collection

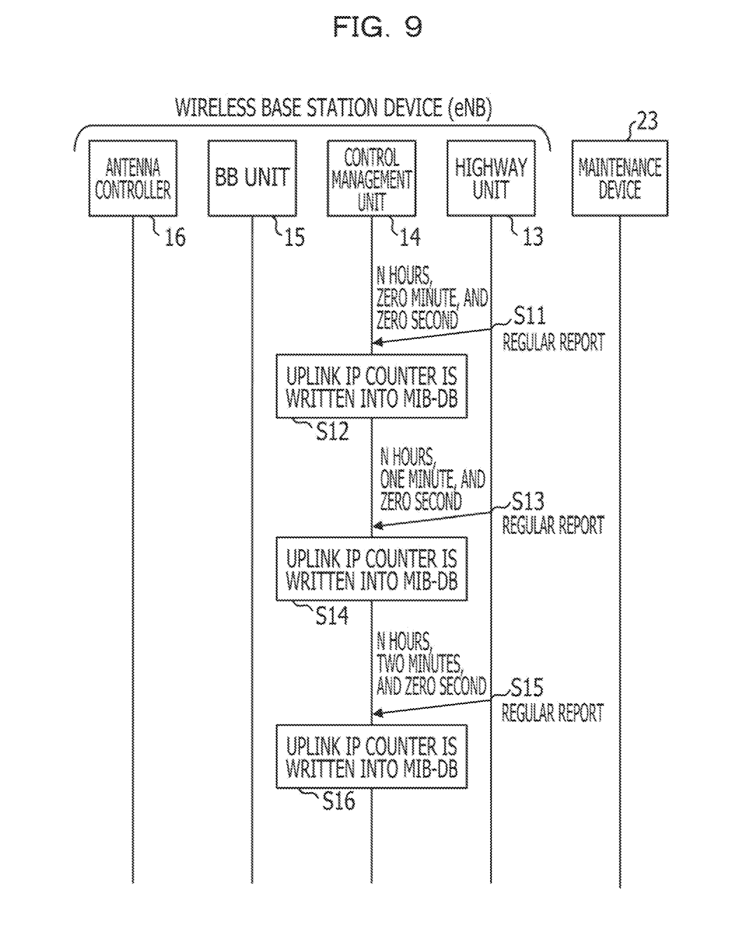

FIG. 9 illustrates a sequence of an embodiment of a regular collection operation. In FIG. 9, between processing operations executed in the data collection unit 52 in the highway unit 13, the data collection unit 52 regularly (for example, at 60-seconds interval) transmits, for example, an uplink IP counter (the number of transmission IP packets and the number of discard IP packets) to the control management unit 14 (Operations S11, S13, and S15). In addition, the uplink IP counter may include the number of reception IP packets in addition to the number of transmission IP packets and the number of discard IP packets.

The control management unit 14 writes the received uplink IP counter (the number of transmission IP packets and the number of discard IP packets) into the MIB-DB 40 (namely, the “Value” of data in specific OIDs in the MIB-DB 40), and updates the MIB-DB 40 (Operations S12, S14, and S16). At this time, the periods of validity of the number of transmission IP packets and the number of discard IP packets on an uplink in the MIB-DB 40 are individually set to “10 seconds”.

The regular collection is regularly performed between processing operations executed in the data collection unit 52, and the control management unit 14 does not instruct the highway unit 13 to read the uplink IP counter. Therefore, the load of a collection processing operation can be reduced.

### New Data Collection: Beyond Period of Validity

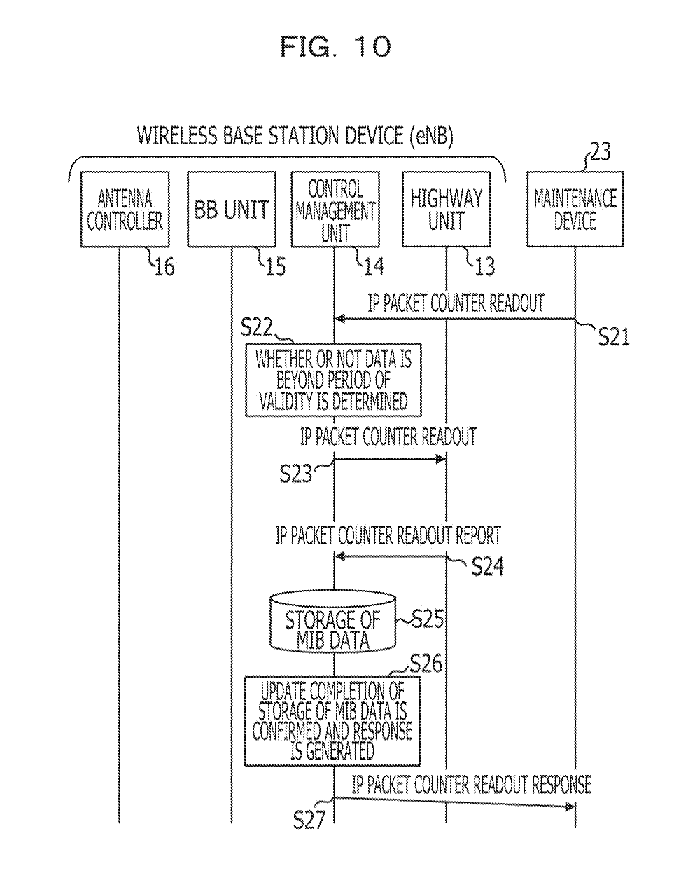

FIG. 10 illustrates a sequence of an embodiment of a new data collection operation. In FIG. 10, for example, when the maintenance device 23 transmits an SNMP message (which includes specific OIDs that indicate the number of transmission IP packets and the number of discard IP packets) that requests to read the uplink IP counter (to which the number of reception IP packets may be added in addition to the number of transmission IP packets and the number of discard IP packets), the SNMP message is supplied to the control management unit 14 through the highway unit 13 in the wireless device controller 11 (Operation S21).

The control management unit 14 reads the requested data of the uplink IP counter from a specific OID in the MIB-DB 40, and compares a value, obtained by adding the value of the period of validity to the value of the time stamp of the read data, with a current time, thereby determining whether or not the data of the uplink IP counter is beyond the period of validity (Operation S22).

When the data of the uplink IP counter is beyond the period of validity, the control management unit 14 transmits a request (single request) for reading the latest value of the uplink IP counter, namely, the latest values of the number of transmission IP packets and the number of discard IP packets on an uplink, to the highway unit 13 (Operation S23).

The highway unit 13 reads the latest value of the uplink IP counter, namely, the latest values of the number of transmission IP packets and the number of discard IP packets on the uplink, from the highway DB 60, and reports the latest values to the control management unit 14 (Operation S24).

The control management unit 14 writes the latest values of the number of transmission IP packets and the number of discard IP packets on the uplink, which have been received, into the MIB-DB 40 (namely, the “Value” of data in specific OIDs in the MIB-DB 40), and updates the MIB-DB 40 (Operation S25).

After that, when confirming the update of the MIB-DB 40, the control management unit 14 generates an SNMP message used for an uplink IP counter read response that includes the number of transmission IP packets and the number of discard IP packets on the uplink, which are updated (Operation S26), and transmits the SNMP message to the maintenance device 23 through the highway unit 13 (Operation S27).

In this way, a time stamp and a period of validity are set in data in the MIB-DB 40. In addition, for example, in a case in which a request for reading the uplink IP counter is performed, when the uplink IP counter is beyond the period of validity, the uplink IP counter is read from the highway unit 13, and hence latest operation information may be collected. Therefore, since a collection processing operation may be reduced, the load of the collection processing operation may be reduced.

### New Data Collection: Within Period of Validity

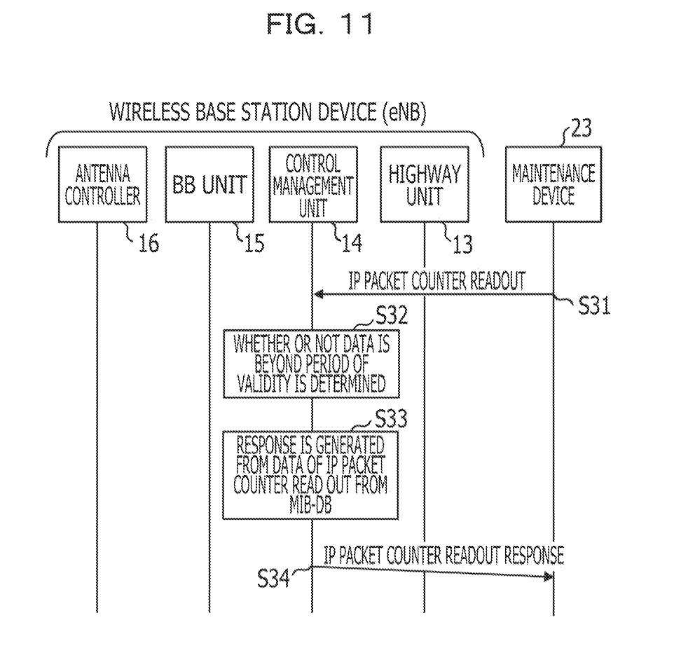

FIG. 11 illustrates a sequence of another embodiment of the new data collection operation. In FIG. 11, for example, when the maintenance device 23 transmits an SNMP message (which includes specific OIDs that indicate the number of transmission IP packets and the number of discard IP packets) that requests to read the uplink IP counter (to which the number of reception IP packets may be added in addition to the number of transmission IP packets and the number of discard IP packets), the SNMP message is supplied to the control management unit 14 through the highway unit 13 in the wireless device controller 11 (Operation S31).

The control management unit 14 reads the requested data of the uplink IP counter from the MIB-DB 40 (namely, a specific OID in the MIB-DB 40), and compares a value, obtained by adding the value of the period of validity to the value of the time stamp of the read data, with a current time, thereby determining whether or not the data of the uplink IP counter is beyond the period of validity (Operation S32).

When the data of the uplink IP counter is within the period of validity, the control management unit 14 generates an SNMP message used for an uplink IP counter read response that includes the uplink IP counter, namely, the number of transmission IP packets and the number of discard IP packets on the uplink, which are read from the MIB-DB 40 (Operation S33), and transmits the SNMP message to the maintenance device 23 through the highway unit 13 (Operation S34).

### New Data Collection: Reread Within Period of Validity

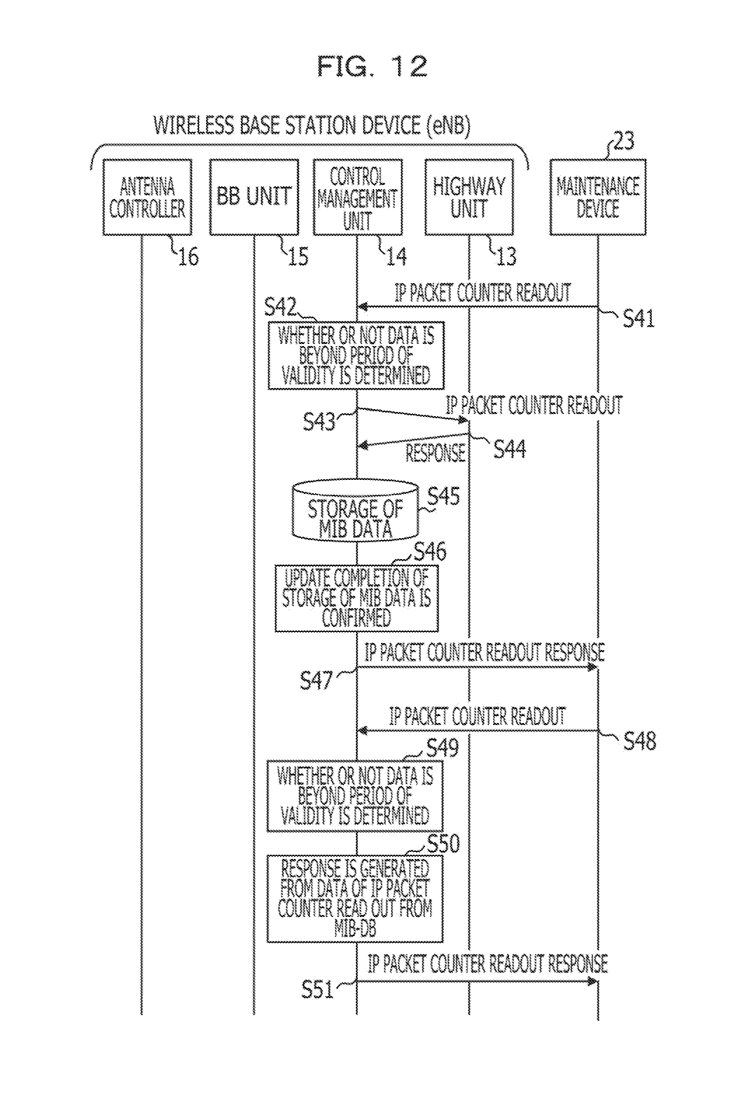

FIG. 12 illustrates a sequence of another embodiment of the new data collection operation. In FIG. 12, for example, when the maintenance device 23 transmits an SNMP message (which includes specific OIDs that indicate the number of transmission IP packets and the number of discard IP packets) that requests to read the uplink IP counter (to which the number of reception IP packets may be added in addition to the number of transmission IP packets and the number of discard IP packets), the SNMP message is supplied to the control management unit 14 through the highway unit 13 in the wireless device controller 11 (Operation S41).

The control management unit 14 reads the requested data of the uplink IP counter from a specific OID in the MIB-DB 40, and compares a value, obtained by adding the value of the period of validity to the value of the time stamp of the read data, with a current time, thereby determining whether or not the data of the uplink IP counter is beyond the period of validity (Operation S42).

When the data of the uplink IP counter is beyond the period of validity, the control management unit 14 transmits a request (single request) for reading the latest value of the uplink IP counter, namely, the latest values of the number of transmission IP packets and the number of discard IP packets on an uplink, to the highway unit 13 (Operation S43).

The highway unit 13 reads the latest value of the uplink IP counter, namely, the latest values of the number of transmission IP packets and the number of discard IP packets on the uplink, from the highway DB 60, and reports the latest values to the control management unit 14 (Operation S44).

The control management unit 14 writes the latest values of the number of transmission IP packets and the number of discard IP packets on the uplink, which been received, into the MIB-DB 40 (namely, the “Value” of data in specific OIDs in the MIB-DB 40), and updates the MIB-DB 40 (Operation S45).

After that, when confirming the update of the MIB-DB 40, the control management unit 14 generates an SNMP message used for an uplink IP counter read response that includes the number of transmission IP packets and the number of discard IP packets on the uplink, which are updated (Operation S46), and transmits the SNMP message to the maintenance device 23 through the highway unit 13 (Operation S47).

After that, when the maintenance device 23 transmits again an SNMP message (which includes specific OIDs that indicate the number of transmission IP packets and the number of discard IP packets) that requests to read the uplink IP counter (to which the number of reception IP packets may be added in addition to the number of transmission IP packets and the number of discard IP packets), the SNMP message is supplied to the control management unit 14 through the highway unit 13 in the wireless device controller 11 (Operation S48).

The control management unit 14 reads the requested data of the uplink IP counter, which has been received, from the MIB-DB 40 (namely, a specific OID in the MIB-DB 40), and compares a value, obtained by adding the value of the period of validity to the value of the time stamp of the read data, with a current time, thereby determining whether or not the data of the uplink IP counter is beyond the period of validity (Operation S49).

When the data of the uplink IP counter is within the period of validity, the control management unit 14 generates an SNMP message used for an uplink IP counter read response that includes the uplink IP counter, namely, the number of transmission IP packets and the number of discard IP packets on the uplink, which are read from the MIB-DB 40 (Operation S50), and transmits the SNMP message to the maintenance device 23 through the highway unit 13 (Operation S51).

### Composite Data Collection

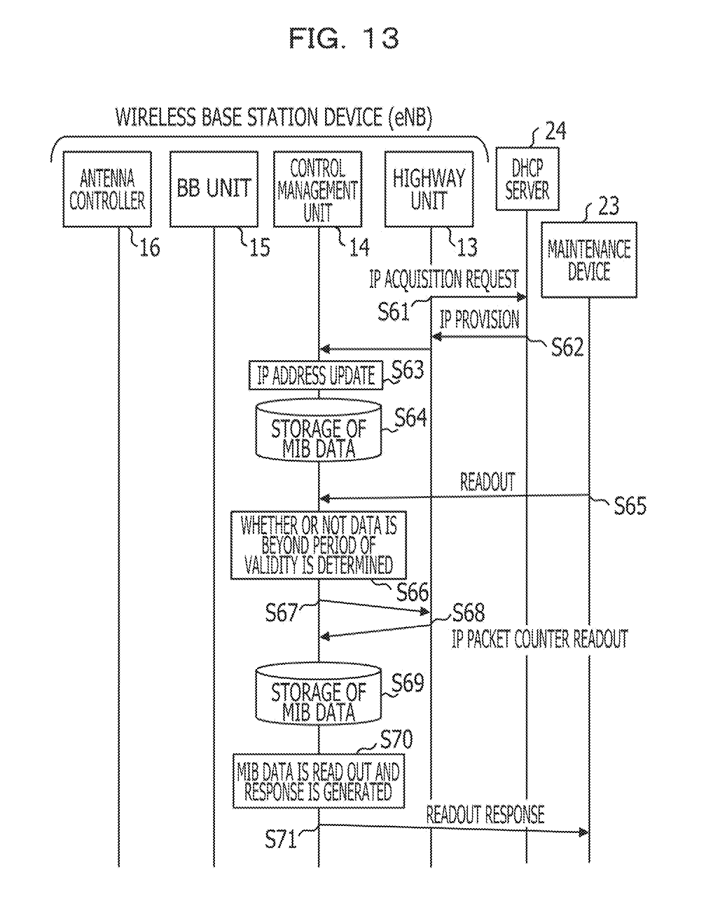

FIG. 13 illustrates a sequence of an embodiment of a composite data collection operation. In FIG. 13, for example, when the period of validity of the IP address of the control management unit 14 has expired, the DHCP controller 62 in the highway unit 13 transmits a request for automatic updating of the IP address to the DHCP server 24 (Operation S61).

The DHCP server 24 transmits an IP address to which a new period of validity is assigned to the highway unit 13, and the highway unit 13 transmits the received IP address of the control management unit 14 to the control management unit 14 (Operation S62).

The control management unit 14 sets the received IP address to a portion the period of validity of which has expired, and updates the IP address thereof (Operation S63). In addition, the control management unit 14 writes the IP address into the MIB-DB 40 (namely, the “Value” of data in a specific OID in the MIB-DB 40), and updates the MIB-DB 40 (Operation S64). At this time, the period of validity of the IP address in the MIB-DB 40 is defined as “NoLimite”.

After that, for example, when the maintenance device 23 transmits an SNMP message (which includes specific OIDs that indicate the IP address of the control management unit 14, the number of transmission IP packets, and the number of discard IP packets) that requests to read the IP address of the control management unit 14 and the uplink IP counter (to which the number of reception IP packets may be added in addition to the number of transmission IP packets and the number of discard IP packets), the SNMP message is supplied to the control management unit 14 through the highway unit 13 in the wireless device controller 11 (Operation S65).

The control management unit 14 reads the requested data of the IP address of the control management unit 14 and the uplink IP counter from specific OIDs in the MIB-DB 40, and compares a value, obtained by adding the value of the period of validity to the value of the time stamp of the read data, with a current time, thereby determining whether or not the IP address of the control management unit 14 and the data of the uplink IP counter are beyond the periods of validity (Operation S66).

When the data of the uplink IP counter is beyond the period of validity (the IP address of the management unit 14 is within the period of validity), the control management unit 14 transmits a request (single request) for reading the latest value of the uplink IP counter, namely, the latest values of the number of transmission IP packets and the number of discard IP packets on the uplink, to the highway unit 13 (Operation S67).

The highway unit 13 reads the latest value of the uplink IP counter, namely, the latest values of the number of transmission IP packets and the number of discard IP packets on the uplink, from the highway DB 60, and reports the latest values to the control management unit 14 (Operation S68).

The control management unit 14 writes the latest values of the number of transmission IP packets and the number of discard IP packets on the uplink, which have been received, into the MIB-DB 40 (namely, the “Value” of data in specific OIDs in the MIB-DB 40), and updates the MIB-DB 40 (Operation S69).

After that, when confirming the update of the MIB-DB 40, the control management unit 14 generates an SNMP message used for an uplink IP counter read response that includes the IP address of the control management unit 14, read from the MIB-DB 40, and the number of transmission IP packets and the number of discard IP packets on the uplink, which are updated (Operation S70), and transmits the SNMP message to the maintenance device 23 through the highway unit 13 (Operation S71).

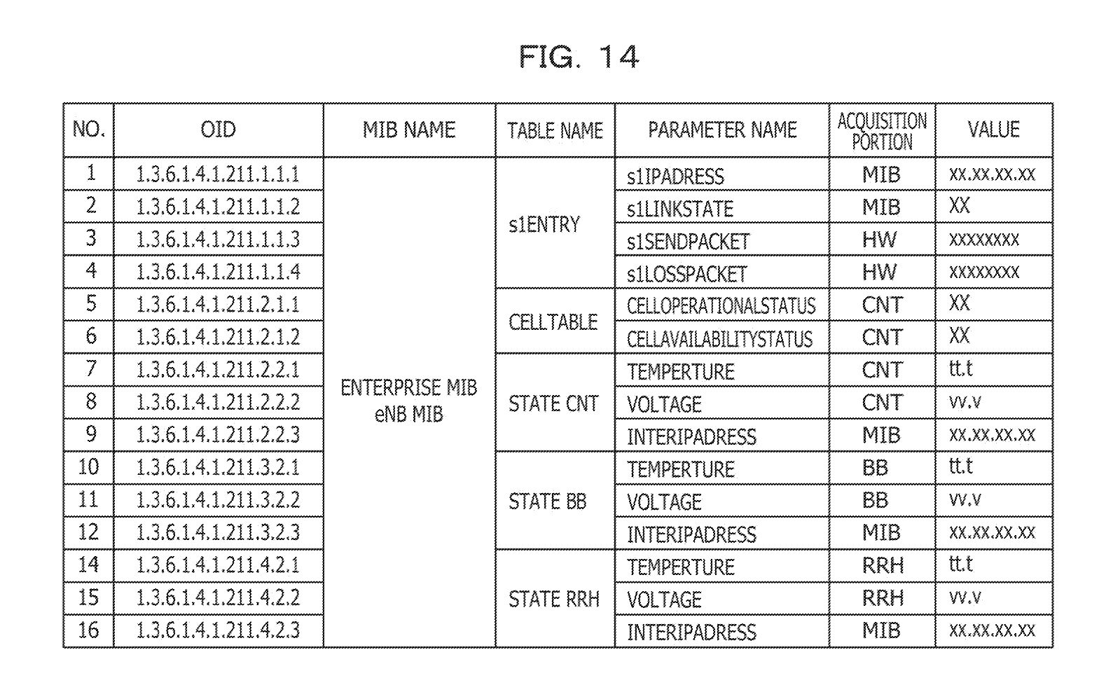

In the embodiment mentioned above, an MIB name, a table name, a parameter name, a time stamp, a period of validity, and a value (Value) are set in each OID in the MIB-DB 40. However, as illustrated in FIG. 14, the MIB-DB 40 may have a configuration in which the time stamp and the period of validity are deleted, and an acquisition portion for operation information, which is preliminarily defined, when an SNMP message is received is set in palace of the time stamp and the period of validity.

In FIG. 14, with respect to an acquisition portion, “MIB” indicates that the operation information is acquired from the MIB-DB 40 when an SNMP message is received, “HW” indicates that the operation information is acquired from the highway unit 13 when an SNMP message is received, “CNT” indicates that the operation information is acquired from the control management unit 14 when an SNMP message is received, “BB” indicates that the operation information is acquired from the baseband processing unit 15 when an SNMP message is received, and “RRH” indicates that the operation information is acquired from the wireless device 12 when an SNMP message is received.

In this case, in each of Operation S6 in FIG. 8, Operation S22 in FIG. 10, Operation S32 in FIG. 11, and Operation S42 in FIG. 12, whether or not data is beyond the period of validity is not determined on the basis of the time stamp and the period of validity but the operation information is acquired from an acquisition portion of data in the MIB-DB 40. In the embodiment, latest operation information can also be collected, and a collection processing operation can also be kept to the minimum. Therefore, the load of the collection processing operation can be reduced.

In addition, while the MIB-DB 40 and the data attribute table 41 are separately provided in the embodiment, the MIB-DB 40 and the data attribute table 41 may be integrated by setting the data save location, the internal request ID, and the internal parameter ID in individual OIDs in the MIB-DB 40.

All examples and conditional language recited herein are intended for pedagogical purposes to aid the reader in understanding the invention and the concepts contributed by the inventor to furthering the art, and are to be construed as being without limitation to such specifically recited examples and condition. Although the embodiment of the present inventions have been described in detail, it should be understood that the various changes, substitutions, and alternations could be made hereto without departing from the spirit and scope of the invention.

What is claimed is:

1. A wireless base station device to connect to a network and communicate with an external device, the wireless base station device comprising:
a control management unit to store operation information in a database and manage the operation information, which relates to control of communication and a processing operation performed in the wireless base station device, wherein
the database stores therein an acquisition time and date and a period of validity along with the operation information, and
the control management unit includes
an operation information read portion to read operation information, which corresponds to a request from the external device, from the database in accordance with the request for reading the operation information;
a determination portion to determine whether or not the operation information that corresponds to the request is beyond a period of validity on the basis of an acquisition time and date and a period of validity, read from the database along with the operation information that corresponds to the request;
an operation information update portion to read the operation information that corresponds to the request from corresponding units when the operation information that corresponds to the request is beyond the period of validity, and updating the database; and
a response transmission portion to transmit, as a response, the operation information read from the database or operation information that corresponds to a request for updating the database to the external device.

2. The wireless base station device according to claim 1, wherein
the operation information update portion substantially simultaneously reads a plurality of pieces of operation information, which correspond to the request from the corresponding units.

3. A wireless base station device to connect to a network and communicate with an external device, the wireless base station device comprising:
a control management unit to store operation information in a database and manage the operation information, which relates to control of communication and a processing operation performed in the wireless base station device, wherein
an acquisition portion is defined so that the acquisition portion corresponds to the operation information stored in the database, and
the control management unit includes
an operation information read portion to read operation information, which corresponds to a request, from the database when an acquisition portion of the operation information, which corresponds to and is specified by the request for reading the operation information, supplied from the external device is the database;
a operation information update portion to read the operation information that corresponds to the request from the acquisition portion of each unit when the acquisition portion of the operation information that corresponds to the request is not the database, and updating the database; and
a response transmission portion to transmit, as a response, the operation information read from the database, which corresponds to the request, or operation information that corresponds to a request for updating the database to the external device.

4. The wireless base station device according to claim 3, wherein
the operation information update portion substantially simultaneously reads a plurality of pieces of operation information, which correspond to the request, from the acquisition portion.

5. The wireless base station device according to claim 1, further comprising:
a wireless transmission and reception portion to transmit and receive a wireless signal;
a communication portion to communicate with the external device with being connected to the network; and
a signal processing portion to perform a baseband processing operation for an uplink and a downlink and to connect to the wireless transmission and reception portion and the communication portion, wherein
each of the wireless transmission and reception portion, the communication portion, and the signal processing portion includes an operation information regular update portion for regularly transmitting operation information of the units to the control management unit and updating the database.

6. An operation information collection method for a wireless base station device that is connected to a network, communicates with an external device, and includes a control management unit configured to store operation information in a database and manage the operation information, which relates to control of the communication and a processing operation performed in the wireless base station device, the operation information collection method comprising:
storing in the database an acquisition time and date and a period of validity along with the operation information;
causing the control management unit to read operation information, which corresponds to a request, from the database in accordance with the request for reading the operation information, supplied from the external device;
determining whether or not the operation information that corresponds to the request is beyond a period of validity on the basis of an acquisition time and date and a period of validity, read from the database along with the operation information that corresponds to the request;
reading the operation information that corresponds to the request from corresponding units when the operation information that corresponds to the request is beyond the period of validity, and updating the database; and
transmitting, as a response, the operation information read from the database or operation information that corresponds to a request for updating the database to the external device.

7. An operation information collection method for a wireless base station device that is connected to a network, communicates with an external device, and includes a control management unit configured to store operation information in a database and manage the operation information, which relates to control of the communication and a processing operation performed in the wireless base station device, the operation information collection method comprising:
defining an acquisition portion so that the acquisition portion corresponds to the operation information stored in the database;
causing the control management unit to read operation information, which corresponds to a request, from the database when an acquisition portion of the operation information, which corresponds to and is specified by the request for reading the operation information, supplied from the external device is the database;
reading the operation information that corresponds to the request from the acquisition portion of each units when the acquisition portion of the operation information that corresponds to the request is not the database, and updating the database; and
transmitting, as a response, the operation information read from the database, which corresponds to the request, or operation information that corresponds to a request for updating the database to the external device.

8. The operation information collection method according to claim 6, wherein
when the operation information, which corresponds to the request, is read from the corresponding units, a plurality of pieces of operation information, which correspond to the request, are substantially simultaneously read.

9. The operation information collection method according to claim 7, wherein
when the operation information, which corresponds to the request, is read from the acquisition portion, a plurality of pieces of operation information, which correspond to the request, are substantially simultaneously read.
